(19) United States
(12) Patent Application Publication
(10) Pub. No.: US 2017/0358010 A1
(43) Pub. Date: Dec. 14, 2017

(54) SYSTEM AND METHOD FOR INCORPORATING BRANDED CREATIVE CONTENT INTO MESSAGING SERVICES

(71) Applicant: Emogi Technologies, Inc., New York, NY (US)

(72) Inventors: Travis Montaque, New York, NY (US); Michael Ojemann, Concord, MA (US); Keisuke Inoue, Astoria, NY (US); Oleksandr Pasichnyk, Kiev (UA); Philip Scheffer, Brooklyn, NY (US); Maximilian Guilbert, New York, NY (US)

(21) Appl. No.: 15/270,938

(22) Filed: Sep. 20, 2016

Related U.S. Application Data
(60) Provisional application No. 62/347,170, filed on Jun. 8, 2016.

(51) Int. Cl. G06Q 30/02

(52) U.S. Cl. CPC G06Q 30/0275

(57) ABSTRACT

A system and method for incorporating branded creative contents into messaging services. In one embodiment, a method comprises receiving profile data associated with a user of a user device; receiving a plurality of bids, the plurality of bids corresponding to bids generated by a plurality of advertisers for providing branded creative contents to user devices; identifying a subset of the plurality of bids based on the profile data associated with the user; generating a set of conditions for identifying a winning bid within the subset of the plurality of bids; and transmitting, to the user device or an intermediate device, data descriptive of the subset of the plurality of bids, identifiers of creative contents associated each bid of the subset, and the set of conditions.

### CROSS-REFERENCE TO RELATED APPLICATION

This application claims the benefit of priority of U.S. Provisional Patent Application Ser. No. 62/347,170, filed Jun. 8, 2016, the disclosure of which is hereby incorporated by reference herein in its entirety.

### TECHNICAL FIELD

This disclosure relates to the field of online advertising, and, more particularly, to the monetization of creative contents in messaging platforms.

### BACKGROUND

Consumer use of messaging has shown remarkable growth over the past several years. At the same time, consumer use of emoji and other digital media in one-to-one messaging systems has shown the strongest growth in the category. While advertisers have sought to utilize these platforms to promote their products/services, current methods have yielded negligible success in the market.

### BRIEF DESCRIPTION OF THE DRAWINGS

The present disclosure is illustrated by way of example, and not by way of limitation, in the figures of the accompanying drawings, in which:

FIG. 1 illustrates an exemplary system architecture in accordance with embodiments of the disclosure;

FIG. 2A illustrates an exemplary data pipeline implemented by the system architecture in accordance with embodiments of the present disclosure;

FIG. 2B illustrates an exemplary sequence of data communication between the components of the system architecture in accordance with embodiments of the present disclosure;

FIG. 3 is a flow diagram illustrating a method 300 for incorporating branded creative contents into a messaging application in accordance with embodiments of the disclosure;

FIG. 4 is a flow diagram illustrating a sequence in which creative contents are inserted into a messaging application in response to a user action in accordance with embodiments of the disclosure;

FIG. 5 is a flow diagram illustrating a messaging session in accordance with embodiments of the disclosure;

FIG. 6 illustrates an example messaging application user interface in accordance with embodiments of the disclosure;

FIG. 7 illustrates another example messaging application user interface in accordance with embodiments of the disclosure;

FIG. 8 illustrates another example messaging application user interface in accordance with embodiments of the disclosure;

FIG. 9 illustrates another example messaging application user interface in accordance with embodiments of the disclosure;

FIG. 10 illustrates another example messaging application user interface in accordance with embodiments of the disclosure; and

FIG. 11 is a block diagram illustrating an exemplary computer system for use in accordance with embodiments of the disclosure.

### DETAILED DESCRIPTION

Described herein are embodiments for incorporating branded creative contents in messaging services. The system utilizes a bidding process to identify branded content for presenting to a user during use of a messaging application, which may occur before or during use of the messaging application. Depending on actions taken by the user, the messaging application loads the branded creative contents to the messaging application, allowing advertisers to provide branded content without requiring the user to install custom keyboard applications (e.g. Swiftkey, Bitmoji, etc).

An illustrative embodiment is as follows: (1) a user is using a messaging application on his/her personal device and elects to insert an emoji (e.g., a small digital image or icon used to represent ideas, emotions, and/or sentiment) into his/her message; (2) the messaging application sends an indication of this action (which may be referred to as a “bid request”) to an auction management server. The bid request may include information as to a specific emoji that the user selected (e.g., a coffee cup emoji), a type of emoji (e.g., a food/drink related emoji), the user's device information, contextual information (e.g., date/time and geolocation), and/or other data that the application can obtain from the user device; (3) the auction management server may obtain (or may have previously obtained prior to receiving the bid request) profile information related to the user (e.g., demographic information, messaging application use behavior, previously or frequently selected emoji, or other information related to the user) from the user device and/or from third-party partners (e.g., data management platforms); (4) the auction management server may select a winning bid by determining that a bid placed by one of a plurality of advertisers satisfies one or more conditions based on the user action and/or the profile information (e.g., the user selected a coffee cup emoji and a particular advertiser outbids other advertisers that sell coffee products); (5) the auction management server sends information back to the user device that specifies a set of creative contents that are associated with the winning bid (e.g., brand-specific emoji related to coffee, such as a Starbucks logo); (6) based on the information that was sent back, the messaging application retrieves the creative contents from a content delivery network and presents them to the user; (7) the user may select an emoji from the set of creative contents for inserting into his/her message, and then send the message to another user. It is noted that the illustrative embodiment represents a simplified use case, with one or more additional processes occurring before, after, or concurrently so as to avoid interruption of the user experience. It is further noted that some of the above steps may be modified or omitted, and/or may occur at different times, as will become apparent from the following disclosure.

Emoji are most typically cartoonized facial expressions (e.g., smiles, frowns, etc.), but may be graphical representations other than facial expressions, such as hearts, food, thumbs up, thumbs down, etc. Creative contents are not limited to emoji, and may include any type of static image, animation (e.g., GIF), or other form of digital media. Creative contents may also be referred to as “creative content elements”.

In certain embodiments, other types of events may serve as actionable triggers for identifying a winning bid. For example, certain text inputs (e.g., based on keywords), which may be identified based on predictive modeling, may cause a user device to send an indication to the auction management server. In certain embodiments, image processing may be utilized to identify one or more objects within an image sent by the user device, and the identification of such objects may serve as an actionable trigger. For example, with the user device, the user may transmit an image of a person drinking coffee (which may be a photo capture by the user device). The user device, using an image recognition algorithm, may identify the coffee cup within the image, and submit an indication of a user's interest in “coffee” to the auction management server. In certain embodiments, the image processing may have occurred prior to the user sending the image. For example, the coffee cup may have been identified previously, with an identifier of “coffee” having been stored in metadata associated with the image. When the image is later sent, some or all of the metadata of the image may be transmitted to the auction management server.

As another example, if the user enters a pre-defined geographic range with respect to one or more retailers (e.g., the user enters a shopping center with his/her device), this may cause the auction management server to identify a winning bid based on retailers within the pre-defined geographic range. A subset of bids may have been previously filtered based on the user profile data. For example, based on the user's buying habits, two retailers at the shopping center may have been identified as relevant to the user. The auction management server may have defined conditions for determining a winning bid from the subset of bids. For example, if the two retailers are coffee shops, the conditions may be found to be satisfied for either retailer if 1) the user is within the pre-defined range of the retailer; 2) the user has purchased coffee from a coffee retailer on average more than twice per week; 3) a bid price is higher than the bid prices of other retailers that satisfy conditions 1 and 2. In such a case, if both retailers satisfy conditions 1 and 2, but only one of the retailers satisfies condition 3, then the auction management server transmits branded content associated with the retailer with the winning bid (or indications of the branded content, such as URLs for retrieving the content) to the user device. In certain embodiments, the bids may be provided to the auction management server directly by the retailer, an advertiser associated with the retailer, or another entity responsible for promoting the content of the retailer. Such sources of bids may be collectively referred to as “advertisers” in such embodiments, unless stated otherwise.

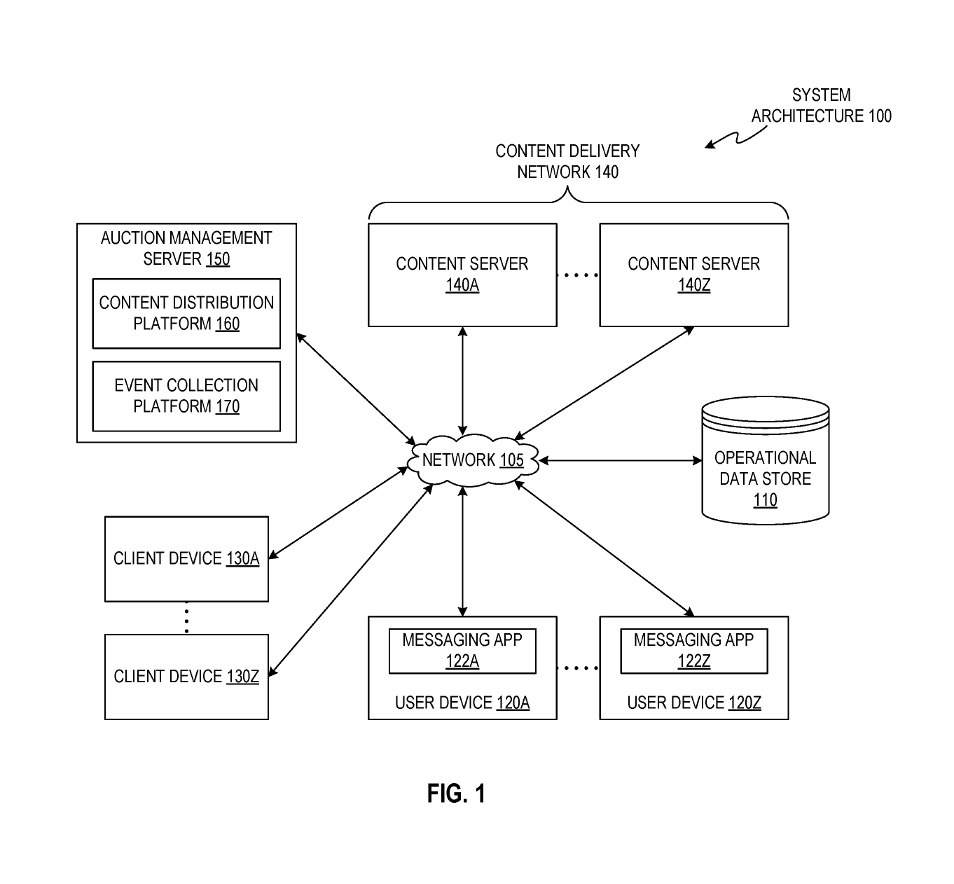

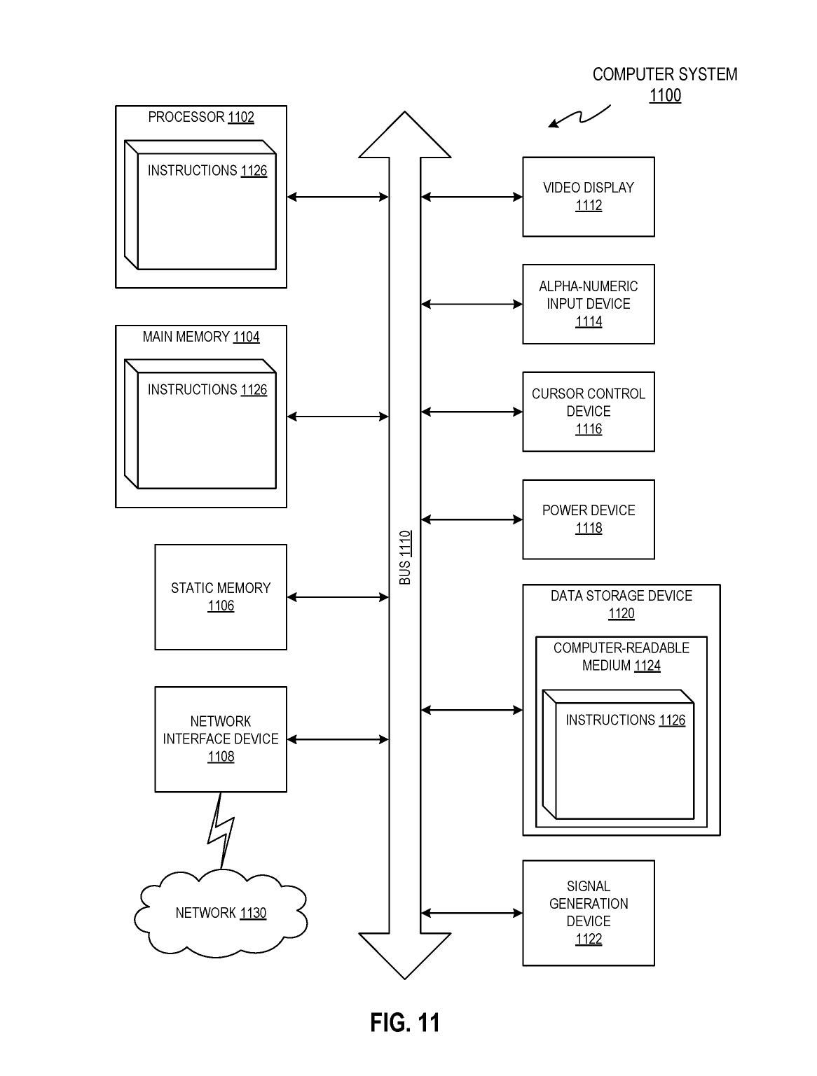

FIG. 1 illustrates an exemplary system architecture 100, in accordance with an embodiment of the disclosure. The system architecture 100 includes an operational data store 110, user devices 120A-120Z, client devices 130A-130Z, content servers 140A-140Z, and an auction management server 150, with each device of the system architecture 100 being communicatively coupled via a network 105. One or more of the devices of the system architecture 100 may be implemented using computer system 1100, described below with respect to FIG. 11.

In one embodiment, network 105 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. Although the network 105 is depicted as a single network, the network 105 may include one or more networks operating as stand-alone networks or in cooperation with each other. The network 105 may utilize one or more protocols of one or more devices to which they are communicatively coupled. The network 105 may translate to or from other protocols to one or more protocols of network devices.

In one embodiment, the operational data store 110 may be a memory (e.g., random access memory), a cache, a drive (e.g., a hard drive), a flash drive, a database system, or another type of component or device capable of storing data. The operational data store 110 may also include multiple storage components (e.g., multiple drives or multiple databases) that may also span multiple computing devices (e.g., multiple server computers). In some embodiments, the operational data store 110 may be cloud-based. One or more of the devices of system architecture 100 may utilize their own storage and/or the operational data store 110 to store public and private data, and the operational data store 110 may be configured to provide secure storage for private data. In some embodiments, the operational data store 110 for data back-up or archival purposes.

The user devices 120A-120Z may each include computing devices such as personal computers (PCs), laptops, mobile phones, smart phones, tablet computers, netbook computers, etc. An individual user may be associated with (e.g., own and/or use) one or more of the user devices 120A-120Z. The user devices 120A-120Z may each be owned and utilized by different users at different locations. As used herein, a “user” or “consumer” is an individual that may use a device to send/receive messages to/from others and may receive content from a content source (e.g., content servers 140A-140Z). However, other embodiments of the disclosure encompass a “user” being an entity controlled by a set of users. For example, a set of individual users federated as a community in a company or government organization may be considered a “user”.

The user devices 120A-120Z may each implement user interfaces that allow their respective user devices 120A-120Z to send/receive data to/from each other, one or more of the client devices 130A-130Z, the operational data store 110, one or more of the content servers 140A-140Z, and the auction management server 150. The user interface, in some embodiments, may be a web browser interface that can access, retrieve, present, and/or navigate content (e.g., web pages such as Hyper Text Markup Language (HTML) pages). The user devices 120A-120Z may each implement messaging applications 122A-122Z, respectively. One or more of the messaging applications 122A-122Z may be a messaging platform (e.g., an application through which users send text-based messages and other content). In one embodiment, one or more of the messaging applications 122A-122Z may be a standalone application (e.g., a mobile “app”, etc.), that allows a user of a respective user device 120A-120Z to send/receive data to/from each other, the operational data store 110, one or more of the client devices 130A-130Z, one or more of the content servers 140A-140Z, and the auction management server 150.

The client devices 130A-130Z may each include computing devices such as personal computers (PCs), laptops, mobile phones, smart phones, tablet computers, netbook computers, etc. The client devices 130A-130Z may each be owned and utilized by different individuals (“clients”). As used herein, a “client” may be a content publisher, a retailer, an advertiser, or other entity that has an interest in obtaining and analyzing data obtained from multiple users (e.g., user of user devices 120A-120Z). Each of the client devices 130A-130Z may allow a client to send/receive data to/from one or more of the client devices 130A-130Z, the operational data store 110, one or more of the content servers 140A-140Z, and the auction management server 150. For example, the client devices 130A-130Z may receive data related to user behavior for visualization, predictive analysis, and profiling.

In one embodiment, the content servers 140A-140Z may each be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components from which content items and metadata may be retrieved/aggregated. In some embodiments, one or more of the content servers 140A-140Z may be a server utilized by any of the user devices 120A-120Z, the client devices 130A-130Z, or the auction management server 150 to retrieve/access content (e.g., an advertisement) or data pertaining to content (e.g., metadata).

In some embodiments, the content servers 140A-140Z may serve as sources of content, which may include advertisements, articles, product descriptions, user-generated content, etc., that can be provided to any of the devices of the system architecture 100. The content servers 140A-140Z may transmit content (e.g., video advertisements, audio advertisements, images, etc.) to one or more of the user devices 120A-120Z. For example, an advertisement may be served to a user device (e.g., the user device 120A) at an appropriate time while a user of the user device is navigating content received from a content source (e.g., one of the content servers 140A-140Z or another server). In certain embodiments, an advertiser utilizing a content server may, in response to winning a bid as is discussed herein, transmit content to one of the user devices 120A-120Z. In certain embodiments, the user may receive, from the auction management server 150, one or more identifier of content associated with the winning bid, and use the one or more identifiers to retrieve branded creative contents from one or more of the content servers 140A-140Z that host the branded creative contents. The creative contents may include, for example, emoji, videos, still images, animated images, or other forms of digital media. The content servers 140A-140Z may collectively be referred to as a content delivery network 140.

In one embodiment, the auction management server 150 may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to evaluate user sentiment. In certain embodiments, the auction management server 150 may receive a bid request from one of the client devices 130A-130Z. In certain embodiments, the auction management server 150 identifies winning bids from bids received from the client devices 130A-130Z (e.g., each being associated with an advertiser for a retailer, or other organization or agency) for the opportunity to present branded creative contents to the client device from which the bid request originated (the “bid originator”). In certain embodiments, the auction management server 150 may request bids from the client devices 130A-130Z to perform a real-time auction. After determining a winning bid, the auction management server 150 may, in some embodiments, transmit identifiers of creative contents associated with the winning bid to the bid originator. In other embodiments, the auction management server 150 may transmit an indication to a device associated with the bid winner, who may then transmit content to the bid originator.

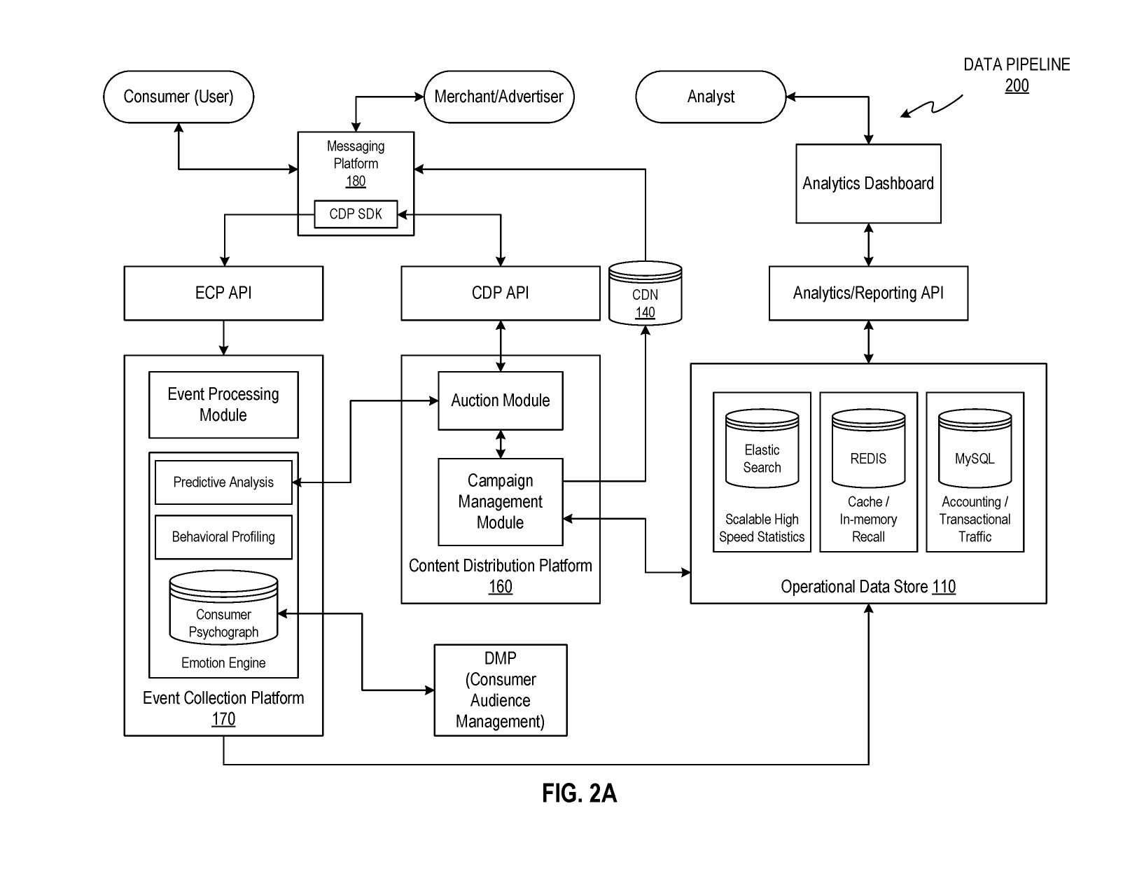

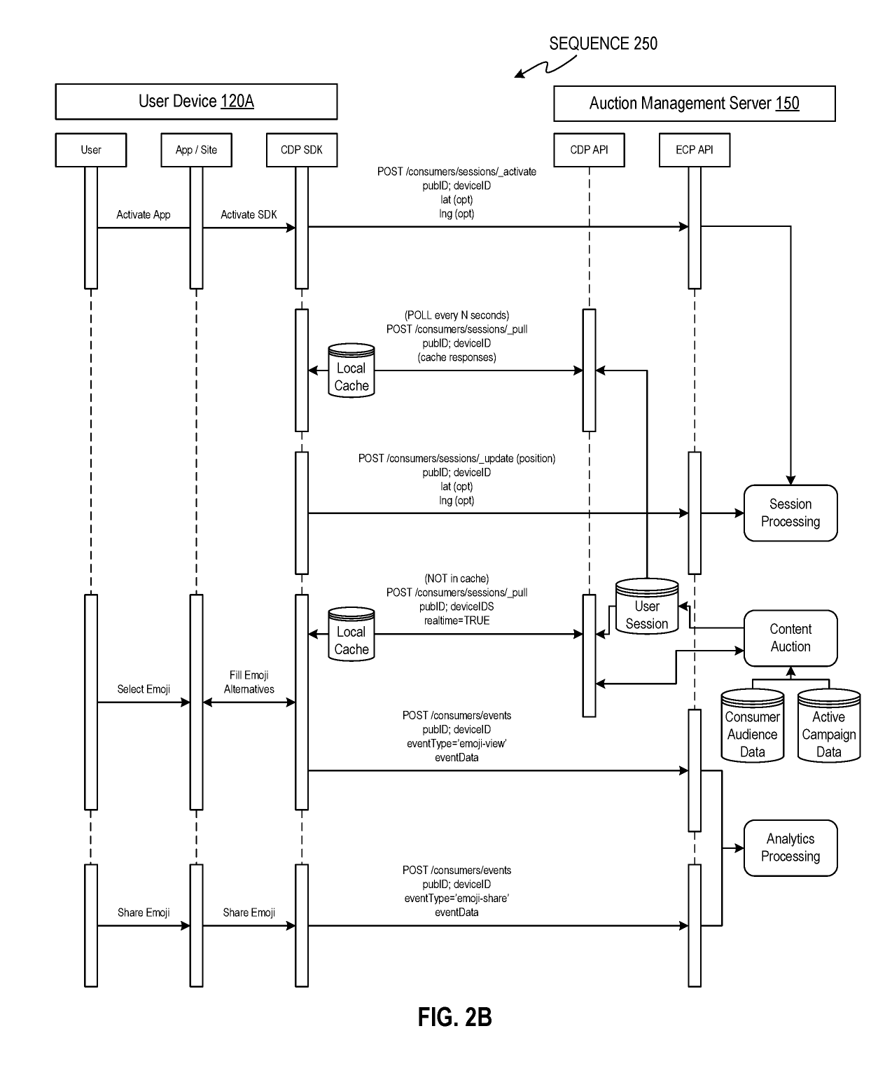

The auction process may be carried out, for example, by a content distribution platform 160 of the auction management server 150. Management of user related data and activities, such as predictive analysis, behavioral profiling, and even processing services, may be carried out, for example, by an event collection platform 170 of the auction management server 150. The functionality of the content distribution platform 160 and the event collection platform 170 are described below with respect to FIGS. 2A and 2B.

FIG. 2A illustrates an exemplary data pipeline 200 implemented by the system architecture 100 in accordance with embodiments of the present disclosure. In certain embodiments, a consumer (user) associated with a user device (e.g., user device 120A), as well as a merchant/advertiser associated with a client device (e.g., client device 130A) may access a messaging platform 180, which interfaces with the content distribution platform 160 and the event collection platform 170 via a content distribution platform (CDP) application program interface (API) and an event collection platform (ECP) API, respectively. The consumer/user may implement a messaging application on his/her user device (e.g., messaging application 122A), which may transmit/receive data to/from the messaging platform 180, which may be hosted on a server separate from the auction management server 150. In certain embodiments, the merchant/advertiser may interface directly with the messaging platform 180, or may interface directly with the content distribution platform 160. FIG. 2B illustrates an exemplary sequence 250 of data communication, which begins at the user device 120A with the activation of the messaging application, followed by activation of the SDK at the messaging platform. Data transmitted to the auction management server 150 is received via the ECP API to process the current user session.

In certain embodiments, the event collection platform 170 utilizes an event processing module that monitors actions and behaviors of users of the messaging platform. For example, the event processing module may determine when messages are sent, the recipients of the messages, text/keywords within the messages before or after the message is sent, creative contents inserted into the messages, and interactions that the user has with the messaging application on his/her user device (e.g., selection of an option to insert a creative content). In certain embodiments, the event collection platform implements an “emotion engine” that performs predictive analysis and behavioral profiling of various users based on their messaging behavior or other metrics, including shopping habits, media consumption, sentiment data describing user sentiment for various brands/advertisements, etc. Collection and processing of sentiment data may be performed as described in U.S. Non-Provisional patent application Ser. No. 15/173,225, filed Jun. 3, 2016, which is hereby incorporated by reference herein in its entirety. The emotion engine may derive emotional or cognitive measures and consumer psychographs based on the data aggregated from various consumers/users. Consumer psychographs may be made available to a data management platform (DMP) for the creation and management of target consumer audiences. Data collected and processed by the event collection platform 170 may be stored, for example, in the operational data store 110, which may be made available to other platforms, including the content distribution platform 160, and a third party analyst. For example, the third party analyst may utilize an analytics dashboard that interfaces with the operational data store 110 via an analytics/reporting API.

In certain embodiments, the content distribution platform 160 utilizes an auction module to conduct an auction process. In certain embodiments, the auction module receives bids from merchants/advertisers. A bid may contain, but is not limited to, the following: data describing a set of creative contents (or identifiers of the creative contents, such as URLs) that a merchant/advertiser desires to present to the consumer via the messaging platform; a bid price; a type of product or service associated with the creative contents; a desired target demographic; one or more geographic locations and rules associated with the locations; and a list of consumers who have purchased the product or service in the past. The merchant/advertiser may submit multiple bids related to the same set of creative contents or for different sets of creative contents. In certain embodiments, the bids are associated with targeting data from the DMP.

In certain embodiments, the auction occurs in real-time. For example, an action taken with the user device 120A (which may be captured by the event processing module and register as a bid request) may cause the auction module to request bids from merchants/advertisers related to the action performed by the consumer. In certain embodiments, the auction is performed prior to any triggerable action taken with the user device 120A, and may be referred to as a “pre-auction”. For example, the auction module may utilize the predictive analysis data generated by the event collection platform 170. This data may be used to generate conditions for the bids that, if satisfy, results in the selection of a winning bid in response to a triggering action of the user device 120A identified by the event processing module. The conditions, which are based on user profile data, may identify a subset of bids that are relevant to a particular consumer/user associated with the profile data. In embodiments where the auction occurs prior to identifying a user action, the content distribution platform 160 may cache the auction results in the operational data store 110 so that they are accessible for later use by the content distribution platform 160 and the event collection platform 170 to minimize server load and response time. In certain embodiments, pre-auction results are retrieved by the user device 120A periodically or in response to specific user activities (e.g., when the user changes location, if the user of the user device 120A changes, etc.). For example, the messaging application 122A may match the user's behavior (e.g., key strokes, selection of a particular emoji, etc.) against the conditions specified in the pre-auction results. If a bid is selected based on the match, the bid is selected as a winning bid.

In certain embodiments, after a winning bid is determined by mapping user inputs/actions of the user device 120A with the conditions associated with the bids, a campaign management module facilitates the transfer of identifiers to the user device 120A via the content delivery network 140. In other embodiments, the user device 120A may have already received the identifiers at an earlier time, such as when pre-auction data was received. The content delivery network 140 allows the user device 120A to retrieve the content through the content delivery network 140 directly without requiring that the auction management server 150 to source the content. Such separation of processes improves overall responsiveness and system scalability. From the perspective of the user device 120A, as indicated in FIG. 2B, the selection of a creative content (e.g., emoji) may cause alternative creative contents associated with a brand (e.g., branded emoji) to be displayed during the user section as a result of the auction process facilitated by the content distribution platform 160.

In certain embodiments, once the creative contents are displayed by the user device 120A, the event processing module receives an “impression event” indication from the user device 120A. The collected impression events are aggregated by the campaign management module and used to calculate the cost charged to the merchant/advertiser (e.g., using a cost-per-mille model). In other embodiments, once one of the creative contents (or identifiers thereof) is sent to one or more recipients, the event processing module receives a “share event” indication. In these cases, the collected share events are aggregated by the campaign management module and used to calculate the cost charged to the merchant advertiser (e.g., using a cost-per-share model). The cost structure may vary depending on the model used. In certain embodiments, a selection or sharing of creative contents (e.g., emoji) may be monitored by the event collection platform 170, as illustrated at the bottom of sequence 250 of FIG. 2B.

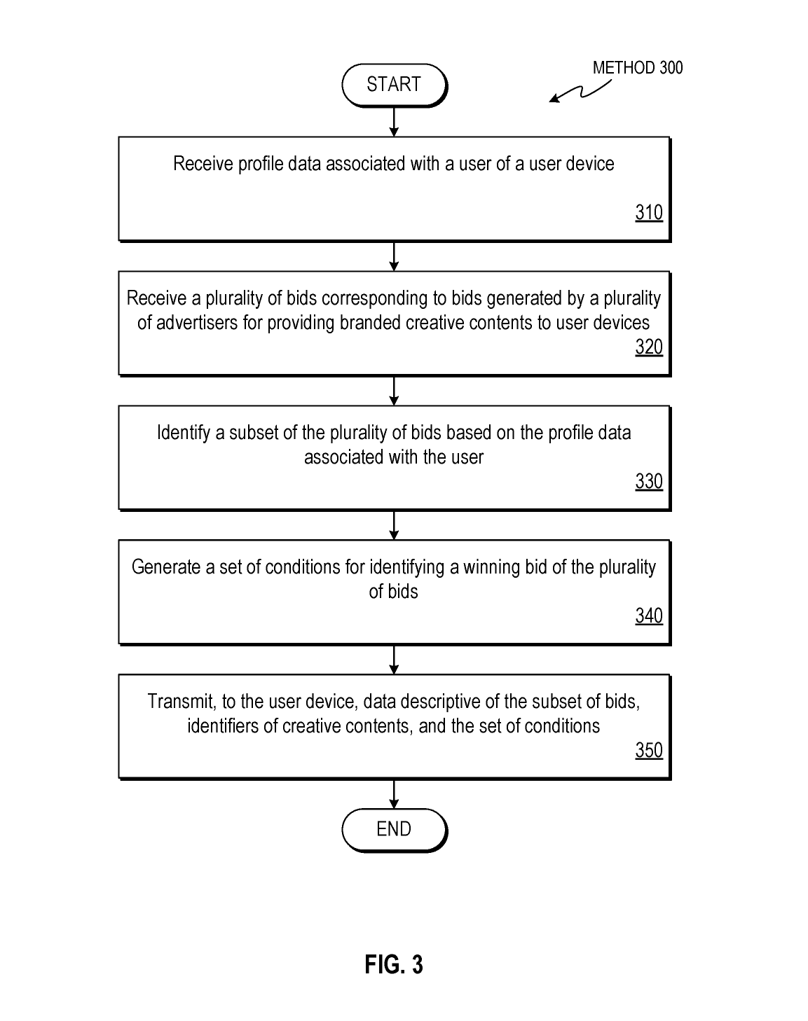

FIG. 3 is a flow diagram illustrating a method 300 for incorporating a branded creative content into a messaging application in accordance with embodiments of the disclosure. The method 300 may be performed by processing logic that includes hardware (e.g., circuitry, dedicated logic, programmable logic, microcode, etc.), software (e.g., instructions run on a processing device to perform hardware simulation), or a combination thereof. In one embodiment, the method 300 is executed, for example, by a processing device of an auction management server (e.g., the auction management server 150). The method 300 is a high-level method intended to broadly encompass several of the embodiments described herein.

The method 300 begins at block 310, where the processing device receives profile data associated with a user of a user device (e.g., user device 120A). In certain embodiments, the profile data comprises one or more of geolocation, demographics, user device data, data related to the messaging application, frequently accessed creative contents, behavioral data (state/mood of the user), time of day in which the messaging application is being used, or other contextual data.

At block 320, the processing device receives a plurality of bids from devices associated with a plurality of advertisers (e.g., client devices 130A-130Z). The plurality of bids correspond to bids by the advertisers for providing branded creative contents to user devices. In certain embodiments, the plurality of bids is received prior to receiving any indication that the user device has activated a messaging application, or before the user has taken any action with the user device.

At block 330, the processing device identifies a subset of the plurality of bids based on the profile data associated with the user. The subset of the plurality of bids may correspond to, for example, bids that have been determined as being relevant to the user. For example, relevancy may be determined by the user's prior purchasing history with merchants that have generated bids, the user's demographic data, etc. The bids, when received by the processing device, may further include targeting information that can be compared to the profile data in determining relevancy.

At block 340, the processing device generates a set of conditions for identifying a winning bid of the plurality of bids. The conditions may be based on the user profile data, targeting data associated with the bids, or other data. For example, in certain embodiments, a merchant/advertiser placing a bid may specify a condition that is to be satisfied in order for its bid to be selected as a winning bid. For example, the merchant/advertiser may stipulate that its creative contents are to be presented to the user upon selection of a particular type of emoji. In certain embodiments, the set of conditions may be generated, at least in part, based on the user profile data. For example, if the user profile data indicates that the user frequently inserts emoji into his/her messages, the set of conditions may include emoji selections as a condition for selecting winning bids.

At block 350, the processing device transmits to the user device data descriptive of the subset of the plurality of bids, identifiers of creative contents associated each bid of the subset, and the set of conditions, which may be cached locally by the user device. In certain embodiments, the subset of bids and the set of conditions may be updated and sent to the user device periodically or in response to a request from the user device. In certain embodiments, the processing device may cache the subset of bids and/or the set of conditions may be cached for future use (e.g., in the operational data store 110).

Using the data received, the user device may monitor the actions taken by the user to determine whether any conditions within the set of conditions are satisfied by the action. In response to detecting an action, the user device may then identify a winning bid from the subset by determining that the action satisfies at least one condition within the set of conditions, with the winning bid being associated with a particular advertiser of the plurality of advertisers that placed the bid. In certain embodiments, the action is a user selection, within a messaging application, of a creative content from a listing of creative contents for insertion into a message. In certain embodiments, the selected creative content is associated with a particular type of creative contents.

After identifying a winning bid, the user device may utilize one or more identifiers of branded creative contents (representative of a brand associated with the winning bid) to retrieve the branded creative contents (i.e., a brand associated with a merchant represented by the advertiser). In certain embodiments, the one or more identifiers are received along with the subset of bids and the set of conditions. In certain embodiments, the one or more identifiers include one or more URLs for retrieving the creative contents, and the user device may retrieve the creative contents from one or more content sources (e.g., content servers 140A-140Z) with the URLs. In certain embodiments, the creative contents are cached locally by the user device, and may have been received along with the subset of bids and the set of conditions.

In certain embodiments, the user device provides a selectable option within the messaging application to insert one or more of the creative contents into a message, as is discussed in greater detail below. In certain embodiments, the processing device receives an indication of an impression event generated in response to a user selection of one of the creative contents or a display of one of the creative contents by the messaging application to the user, and then computes a cost to be charged to the advertiser based on the impression event (e.g., using a cost cost-per-mille model). In certain embodiments, the processing device receives an indication of a share event generated in response to transmission of a message containing the creative contents (or an identifier thereof) to one or more recipients, and then computes a cost to be charged to the advertiser based on the share event (e.g., using a cost cost-per-share model). The advertiser may be charged at each time that a charge is computed, or accumulated charges may be charged at a set time (e.g., daily, weekly, monthly, etc.).

In certain embodiments, the processing device receives an indication that the user device failed to identify a winning bid within the subset. In such embodiments, the processing device may attempt to identify a winning bid within locally cached bid data (e.g., which may be stored on the auction management server 150, the operational data store 110, or in another accessible location). In certain embodiments, if the processing device is also unable to identify additional bids, the processing device may perform an auction (e.g., a real-time auction) to identify additional bids in response to receiving the indication from the user device. The results of the auction may then be cached by the processing device, and an updated set of conditions for identifying a winning bid may be generated.

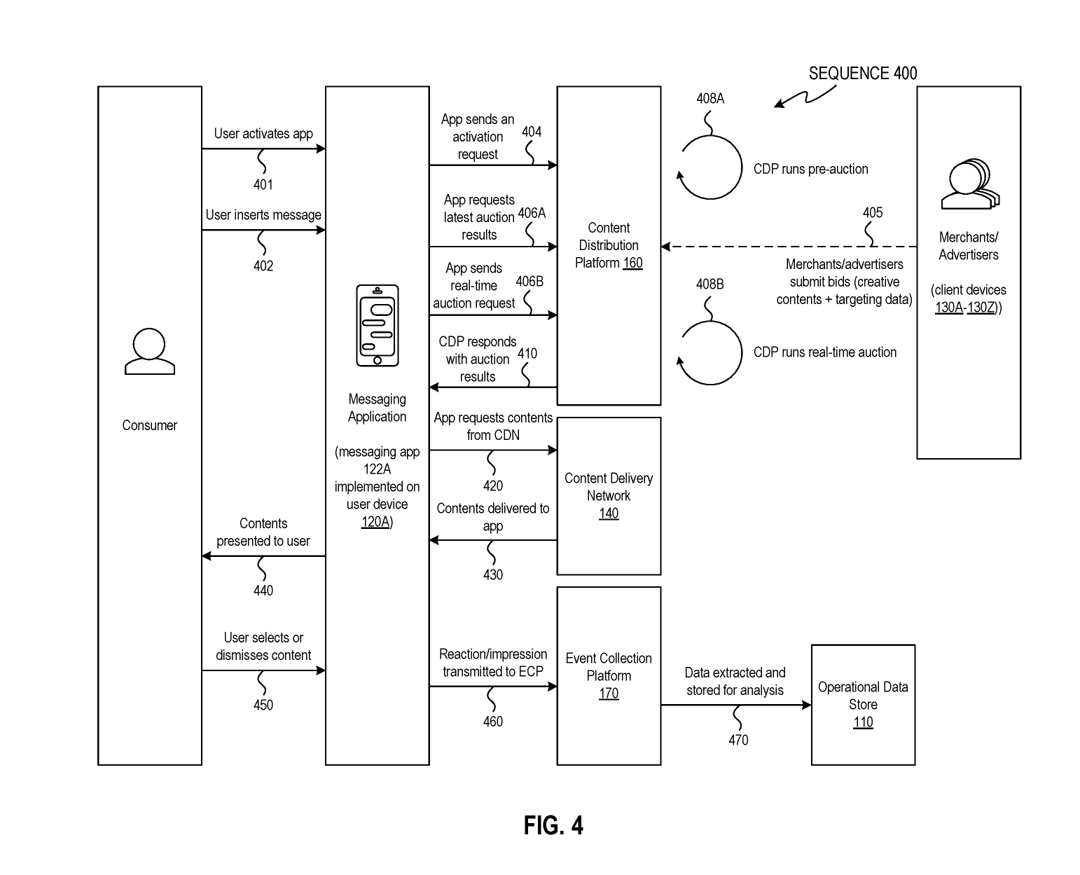

FIG. 4 is a flow diagram illustrating a sequence 400 in which creative contents are inserted into a messaging application in response to a user action to select a creative content in accordance with embodiments of the disclosure. The sequence 400 represents specific embodiment of the method 300, and portions of the method may be executed by various devices of the system architecture 100. At step 401, the user activates the messaging application 122A on the user device 120A, and inserts a message into the messaging application 122A at step 402. For example, when entering the message, the user may select, type, or otherwise indicates an intent of the user to insert an emoji into the message. In certain embodiments, other types of creative contents may be inserted into the message, such as animations or video. At step 404, the messaging application 122A sends an activation request to the content distribution platform 160 indicating that the user is actively using the messaging application 122A. In certain embodiments, the activation request is sent in response to the user opening the messaging application 122A, engaging in a chat with another user or a chatbot, selecting a content tray for inserting creative contents into messages, etc. In certain embodiments, the activation request is sent after the user inserts the message, or before the user inserts the message and after the user activates the app.

At step 405, the merchants/advertisers may transmit bids to the content distribution platform 160. The bid requests from a particular merchant/advertiser may include or be accompanied by targeting data related to target users/consumers. The targeting data may be utilized by the content distribution platform 160 to identify relevant bids and to generate conditions for identifying winning bids in response to one or more actions taken by a specific user. Step 405 may occur at any point during the sequence 400. In certain embodiments, the pre-auction is run by the content distribution platform 160 in response to receiving bids from the merchants/advertisers.

At step 408A, the content distribution platform 160 runs a pre-auction based on previously received data associated with the user to identify a subset of bids that are relevant to the user. The subset corresponds to “preliminary” winning bids, which are bids that may ultimately be selected as winning bids if the user performs an action that triggers the selection of one of these bids. In certain embodiments, the content distribution platform 160 filters the bids based on a bid price. For example, if the content distribution platform 160 identifies two relevant bids from competing advertisers, the bid with the highest bid price may be selected for inclusion in the subset.

In certain embodiments, the pre-auction of step 408A may occur at any time during the sequence 400 such as, for example, before the activation request is received by the content distribution platform 160. In certain embodiments, if the content distribution platform 160 does not have access to user profile data for the user or has limited data, the subset of bids and the set of conditions may be more expansive than if the user profile data was available, since determining relevancy of bids to the particular user is limited.

In certain embodiments, the messaging application 122A may search its local cache to identify winning bids based on a triggerable action performed by the user with the user device (e.g., inserting an emoji into a message, as in step 402). If no winning bids are identified, the sequence 400 may proceed to step 406A where the messaging application 122A requests the latest auction results from the content distribution platform 160. In certain embodiments, step 406A occurs before step 402, and may, for example, occur concurrently with step 404. At step 410, the content distribution platform 160 responds by transmitting the most current auction results to the user device 120A.

In certain embodiments, step 406B may be performed. At step 406B, the messaging application 122A may send a real-time auction request if, for example, no winning bids are identified within locally cached data. In certain embodiments, step 406B occurs in lieu of step 406A. In response to receiving such a request, the content distribution platform 160 may perform a real-time auction at step 408B, which is performed concurrently as the user is interacting with the messaging application 122A.

At step 420, the messaging application 122A requests the creative contents from the content delivery network 140 using identifiers of the creative contents, and at step 4300, the content delivery network 140 transmits the creative contents to the messaging application 122A. At step 440, the creative contents (e.g., branded emoji) are presented for display to the consumer via the messaging application 122A, providing the consumer with an opportunity to select a branded emoji to insert into a message. At step 450, the user may select one or more of the branded emoji to insert into a message, or may forego selecting or dismiss one or more of the selected emoji. At step 460, data describing the user reactions/impressions are transmitted to the event collection platform 170 where, at step 470, analytics data is extracted and stored for later analysis in the operational data store. In certain embodiments, the data is analyzed to gauge user sentiment toward the branded content, and such information may be provided back to the merchant/advertiser associated with the branded content.

In describing sequence 400, the various steps performed were described as being performed by the content distribution platform 160 and the messaging application 122A implemented by the user device 120A. It is to be understood that, in certain embodiments described herein, one or more of these steps may be performed by an intermediate device, such as an intermediate server. The intermediate device, for example, may be any device within the system architecture 100 or in addition to those of the system architecture 100. For example, an intermediate device may be a separate server that implements the messaging platform 180. The intermediate device may perform at least a portion of the functionality described herein in order to improve overall efficiency and scalability of the system. For example, in certain embodiments, step 410 may be modified such that pre-auction results are transmitted to the intermediate device rather than the user device 120A. The intermediate device may identify winning bids, and/or facilitate the retrieval of creative contents for use by the user device 120A, thus reducing the overall load on the user device 120A. One of ordinary skill in the art would appreciate how one or more intermediate devices could be utilized in connection with any of the embodiments described herein, with various permutations of devices performing the disclosed operations being contemplated.

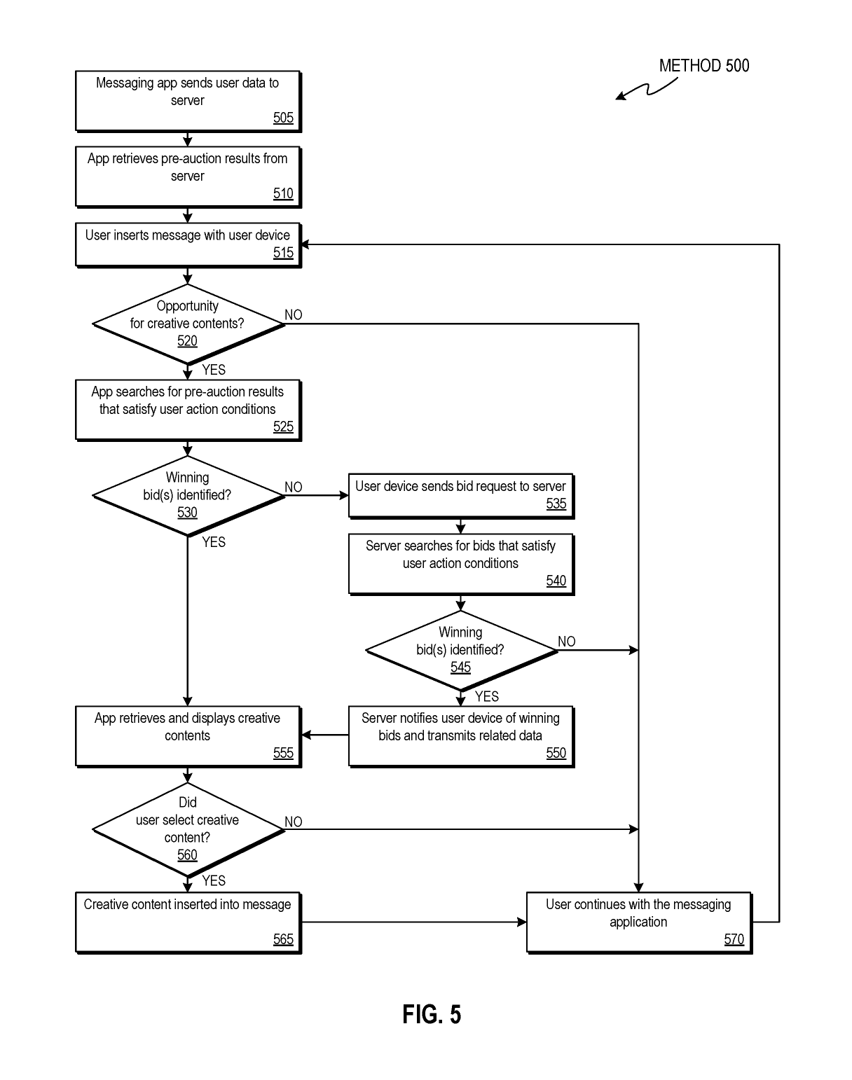

FIG. 5 is a flow diagram illustrating a messaging session utilizing pre-auction data in accordance with embodiments of the disclosure. At block 505, a messaging application of a user device (e.g., messaging application 122A of user device 120A) sends user data to an auction management server (e.g., auction management server 150). The user data includes, for example, user profile data, device profile data, and/or user activity data. At block 510, the messaging application retrieves pre-auction results from the auction management server (i.e., a “pre-fetch” operation), and caches the pre-auction results on the user device. The pre-auction results includes a subset of bids identified by the auction management server based on the user data, along with data describing conditions for selecting a winning bid.

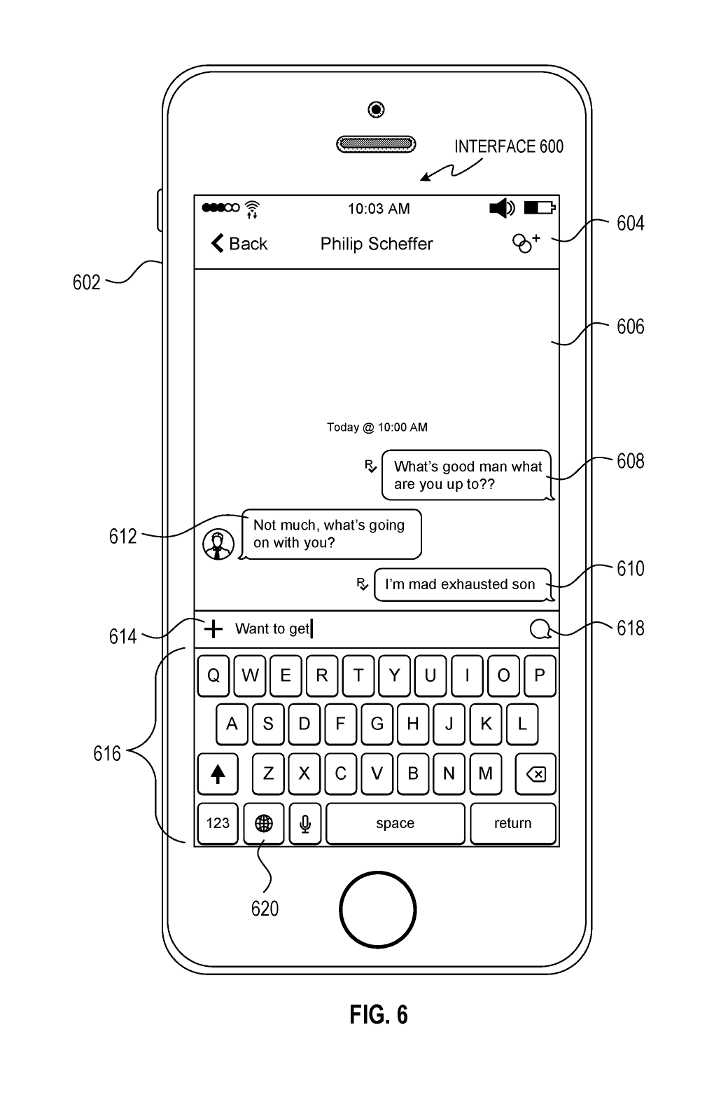

At block 515, a user of a user device enters a message into the user device using a messaging application. This is illustrated in FIG. 6, which shows an exemplary messaging application interface 600 presented by a user device 602 (which may be the same or similar to the user device 120A). The interface 600 includes a header region 604, which may display information relating to the user device 602, text boxes, and other options. The interface 600 also includes a main region 606 that may display various forms of content, such as sent messages and received messages between the user and a recipient. For example, message 608 and message 610 are messages sent to a recipient, and message 612 is a message received from the recipient. The main region 606 further includes a text entry field 614 where the user may type messages or insert various creative contents (e.g., emoji). The interface 600 may present an ASCII keyboard 616 containing ASCII characters to select from when entering the message. The user may send the message by selecting a send option 618.

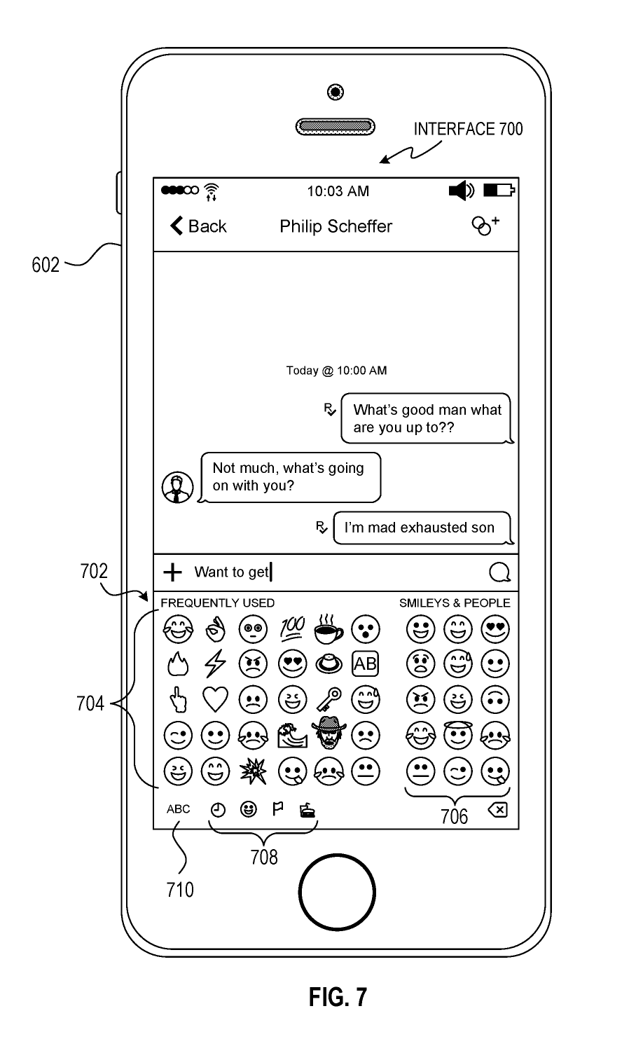

In certain embodiments, a selection of key 620 may cause the keyboard 616 to be replaced by an emoji keyboard 702, as illustrated by interface 700 in FIG. 7. The emoji keyboard 702 includes frequently used emoji 704 and categorized emoji 706. Different categorized emoji may be selected by a selection of one of keys 708. A selection of key 710 may cause the emoji keyboard 702 to revert back to the ASCII keyboard 616 illustrated in FIG. 6.

Referring back to FIG. 5, at block 520, a determination is made (e.g., by a processing device of the user device 602, by the processing device of the auction management server, etc.) as to whether an opportunity for presenting creative contents to the user (e.g., branded creative contents from a particular merchant/advertiser) has become available. In certain embodiments, the availability of this opportunity may be indicated by a particular action performed by the user with the user device 602. In certain embodiments, the action is the typing text into the text entry field 614. In certain embodiments, the action is the typing of an emoji shortcut (e.g., “:-)”, “:-(”, etc.) into the text entry field 614. In certain embodiments, the action is the typing of a particular keyword into the text entry field 614. In certain embodiments, the action is the sending of sending a particular music or audio file, documents containing particular content, or a picture, illustration, or photograph that contains one or more particular objects or themes (e.g. sending a picture of a dog). In certain embodiments, the action is a selection of key 620. In certain embodiments, the action is a selection of an emoji from the emoji keyboard 702. In certain embodiments, the action is the physical relocation of the user device 602 to a pre-defined geographic location. In certain embodiments, actions taken by another user with which the user of the user device 602 is in communication with may represent an opportunity to insert creative contents (e.g., if the user receives a message from the other user containing an emoji or other type of creative contents).

If, at block 520, it is determined that the opportunity is available, the method 500 proceeds to block 525 where the messaging application searches the cached pre-auction results to identify a bid that satisfies one or more conditions related to one or more actions performed by the user with the user device. Otherwise, the method 500 proceeds to block 570 where the user continues with the messaging application.

The conditions (previously generated by the auction management server) relate to particular actions performed by the user that determine whether a particular bid is a winning bid. For example, if five bids are cached on the user device (Bids A-E), and a condition for selecting Bid A as the winning bid is that a user selected a coffee cup emoji for inserting into a message, then Bid A is selected as the winning bid. In certain embodiments, the conditions may require at least two conditions to be satisfied. For example, for Bid B to be selected as the winning bid, the conditions may require that the user has selected a food-themed emoji and is within a pre-defined geographic distance of a particular restaurant. In certain embodiments, two or more bids may be identified as winning bids. For example, if the user action satisfies conditions of both Bid A and Bid B, both Bid A and Bid B may be identified as winning bids. In certain embodiments, one winning bid may receive priority over another winning bid (e.g., if a bid price for Bid A exceeds that of Bid B). In such embodiments, branded creative contents may be presented to the user (discussed below) in a way that prioritizes Bid A over Bid B. For example, creative contents for Bid A may be presented for display by the user device 602 prior to displaying creative contents for Bid B. As another example, creative contents for Bid A may be displayed more prominently than creative contents for Bid B.

If, at block 530, one or more winning bids are identified by the user device, then the method 500 proceeds to block 555. Otherwise, if no winning bids are identified by the user device (or if, for example, there are no cached pre-auction results on the user device), the method 500 proceeds to block 535 where the user device sends a bid request to the auction management server. In certain embodiments, the bid request is accompanied by data describing one or more user actions and/or device data (e.g., geolocation data). At block 540, the auction management server searches for bids (e.g., within cached bid data) that satisfy the conditions related to the user actions (e.g., in a similar manner as described above with respect to block 525). For example, the auction management server may have updated data pertaining to bids and conditions for selecting winning bids, which was not yet provided to the user device.

If, at block 545, one or more winning bids are identified by the auction management server, then the method 500 proceeds to block 550 where the auction management server notifies the user device of the winning bids and transmits related data (e.g., identifiers of creative contents associated with the winning bids). The method 500 then proceeds to block 555. If no winning bids are identified by the auction management server, then the method 500 proceeds to block 570. In certain embodiments, the auction management server may perform a real-time auction to identify bids and generate conditions to identify winning bids.

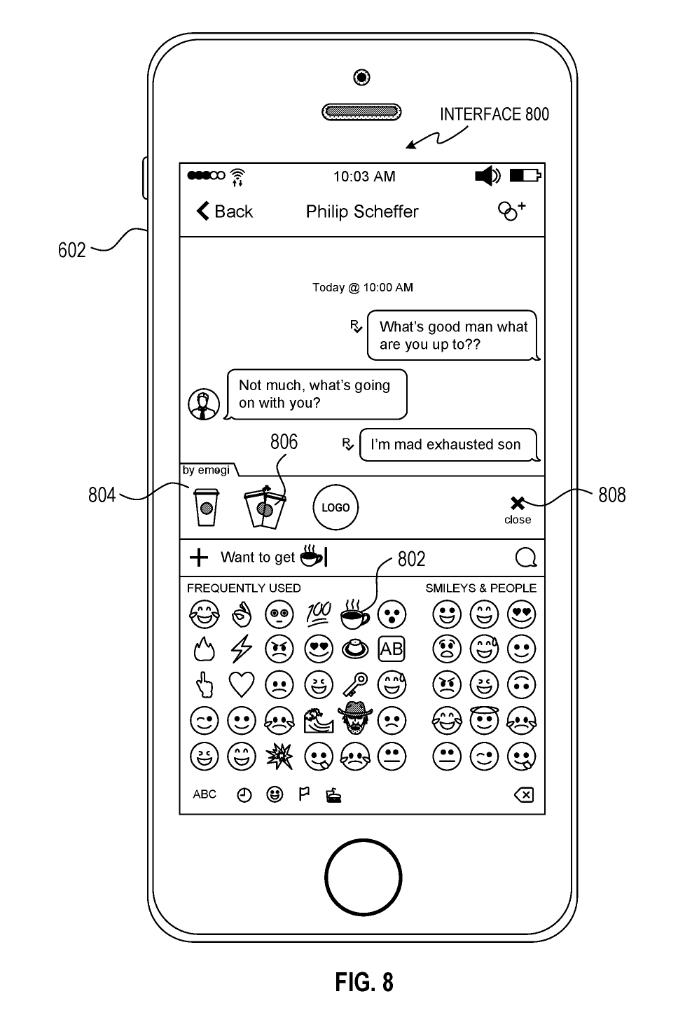

At block 555, the messaging application retrieves branded creative contents (e.g., from the content delivery network 140), for example, based on an identifier of the creative contents associated with the winning bid (e.g., URLs of where the contents are stored). The creative contents may be displayed to the user with the user device as described below with respect to FIG. 8.

FIG. 8 illustrates an interface 800 having a branded contents window 804 in which the received branded creative contents are provided to the user as selectable emoji for inserting into a message. An illustrative example is as follows: the user previously selected a coffee cup emoji 802 to insert into a message. This selection was used to identify a winning bid from cached pre-auction results stored on the user device 602 (or if no winning bid was identified within the pre-auction results, a bid request may be transmitted to an auction management server to identify the winning bid). For example, various data may have been used to determine whether conditions for identifying the winning bid are satisfied, with such data including an identifier of the emoji selected, a type of emoji (e.g., food and drink, coffee, etc.), a time of day when the emoji was selected, a geolocation of the user device 602 when the emoji was selected, or other contextual data. Here, the winning bid corresponds to a bid from a coffee retailer (e.g., a coffee-themed emoji was selected). As a result of identifying this winning bid, the user device 602 presents various emoji indicating the brand of the coffee retailer in the branded contents window 804, such as emoji having a company name, symbol, or other identifier meant to cause the user to think of the brand.

Referring back to FIG. 5, at block 560, the user device 602 determines if the user has selected one of the branded creative contents. If one of the branded creative contents was selected, then the method 500 proceeds to block 565 where the selected content is inserted into a message, and to block 570. Otherwise, the method 500 proceeds to block 570 bypassing block 565.

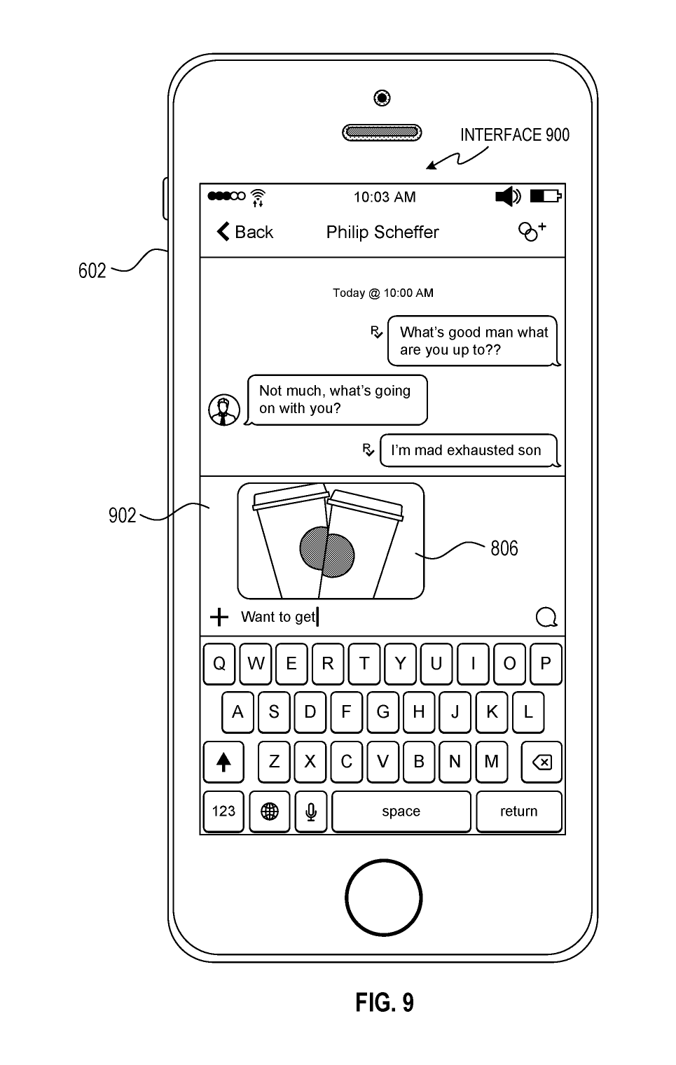

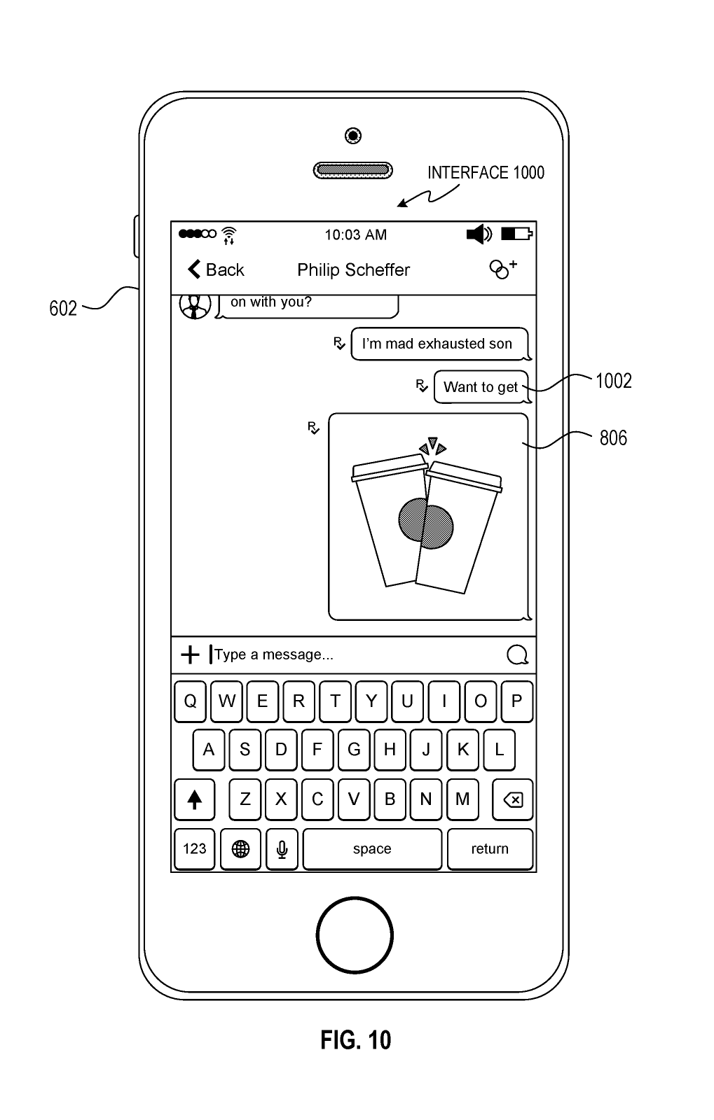

The selection of a branded creative content is illustrated in FIGS. 8 and 9. The user may select one of the emoji from the branded contents window 804 for inserting into a message, or may dismiss the emoji by selecting a close option 808, as shown in FIG. 8. In response to a selection of branded emoji 806, for example, branded emoji 806 appears in a text entry field 902 of interface 900, as illustrated in FIG. 9. If the user elects to send the message at this point, the sent message 1002 and the branded emoji 806 may appear in interface 1000, as illustrated in FIG. 10. An identifier of the branded emoji 806 (e.g., a URL) may be provided to the message recipient's device so that the message recipient's device may retrieve and view the branded emoji 806.

In certain embodiments, an indication of an emoji selection may be interpreted by the auction management server as a click-through event. In certain embodiments, selection of the close option 808 may be interpreted as a bounce event. Depending on which branded emoji are selected and the frequency of selection of branded emoji or dismissal thereof, the auction management server may cache such data so that it can be used to gauge the user's sentiment toward the brand.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture”, as used herein, is intended to encompass a computer program accessible from any computer-readable device or storage media.

FIG. 11 illustrates a diagrammatic representation of a machine in the exemplary form of a computer system 1100 within which a set of instructions (e.g., for causing the machine to perform any one or more of the methodologies discussed herein) may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a television (e.g., a “smart TV”), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Some or all of the components of the computer system 1100 may be utilized by or illustrative of any of the operational data store 110, one or more of the user devices 120A-120Z, one or more of the content servers 140A-140Z, and the auction management server 150.

The exemplary computer system 1100 includes a processing device (processor) 1102, a main memory 1104 (e.g., read-only memory (ROM), flash memory, dynamic random access memory (DRAM) such as synchronous DRAM (SDRAM) or Rambus DRAM (RDRAM), etc.), a static memory 1106 (e.g., flash memory, static random access memory (SRAM), etc.), and a data storage device 1120, which communicate with each other via a bus 1110.

Processor 1102 represents one or more general-purpose processing devices such as a microprocessor, central processing unit, or the like. More particularly, the processor 1102 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1102 may also be one or more special-purpose processing devices such as an application specific integrated circuit (ASIC), a field programmable gate array (FPGA), a digital signal processor (DSP), network processor, or the like. The processor 1102 is configured to execute instructions 1126 for performing the operations and steps discussed herein.

The computer system 1100 may further include a network interface device 1108. The computer system 1100 also may include a video display unit 1112 (e.g., a liquid crystal display (LCD), a cathode ray tube (CRT), or a touch screen), an alphanumeric input device 1114 (e.g., a keyboard), a cursor control device 1116 (e.g., a mouse), and a signal generation device 1122 (e.g., a speaker).

Power device 1118 may monitor a power level of a battery used to power the computer system 1100 or one or more of its components. The power device 1118 may provide one or more interfaces to provide an indication of a power level, a time window remaining prior to shutdown of computer system 1100 or one or more of its components, a power consumption rate, an indicator of whether computer system is utilizing an external power source or battery power, and other power related data. In some embodiments, indications related to the power device 1118 may be accessible remotely (e.g., accessible to a remote back-up management module via a network connection). In some embodiments, a battery utilized by the power device 1118 may be an uninterruptable power supply (UPS) local to or remote from computer system 1100. In such embodiments, the power device 1118 may provide information about a power level of the UPS.

The data storage device 1120 may include a computer-readable storage medium 1124 on which is stored one or more sets of instructions 1126 (e.g., software) embodying any one or more of the methodologies or functions described herein. The instructions 1126 may also reside, completely or at least partially, within the main memory 1104 and/or within the processor 1102 during execution thereof by the computer system 1100, the main memory 1104 and the processor 1102 also constituting computer-readable storage media. The instructions 1126 may further be transmitted or received over a network 1130 (e.g., the network 105) via the network interface device 1108.

In one embodiment, the instructions 1126 include instructions for carrying out one or more of the methods described herein. While the computer-readable storage medium 1124 is shown in an exemplary embodiment to be a single medium, the terms “computer-readable storage medium” or “machine-readable storage medium” should be taken to include a single medium or multiple media (e.g., a centralized or distributed database, and/or associated caches and servers) that store the one or more sets of instructions. The terms “computer-readable storage medium” or “machine-readable storage medium” shall also be taken to include any transitory or non-transitory medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is herein, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “receiving”, “retrieving”, “transmitting”, “computing”, “generating”, “adding”, “subtracting”, “multiplying”, “dividing”, “optimizing”, “calibrating”, “detecting”, “performing”, “analyzing”, “determining”, “enabling”, “identifying”, “modifying”, “matching”, “comparing”, “caching”, “storing”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The disclosure also relates to an apparatus, device, or system for performing the operations herein. This apparatus, device, or system may be specially constructed for the required purposes, or it may include a general purpose computer selectively activated or reconfigured by a computer program stored in the computer. Such a computer program may be stored in a computer- or machine-readable storage medium, such as, but not limited to, any type of disk including floppy disks, optical disks, compact disk read-only memories (CD-ROMs), and magnetic-optical disks, read-only memories (ROMs), random access memories (RAMs), EPROMs, EEPROMs, magnetic or optical cards, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Reference throughout this specification to “an embodiment” or “one embodiment” means that a particular feature, structure, or characteristic described in connection with the embodiment is included in at least one embodiment. Thus, the appearances of the phrase “an embodiment” or “one embodiment” in various places throughout this specification are not necessarily all referring to the same embodiment. Moreover, it is noted that the “A-Z” notation used in reference to certain elements of the drawings is not intended to be limiting to a particular number of elements. Thus, “A-Z” is to be construed as having one or more of the element present in a particular embodiment.

The present disclosure is not to be limited in scope by the specific embodiments described herein. Indeed, other various embodiments of and modifications to the present disclosure pertaining to evaluating user sentiment, in addition to those described herein, will be apparent to those of ordinary skill in the art from the preceding description and accompanying drawings. Thus, such other embodiments and modifications pertaining to evaluating user sentiment are intended to fall within the scope of the present disclosure. Further, although the present disclosure has been described herein in the context of a particular embodiment in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein, along with the full scope of equivalents to which such claims are entitled.

1. A method comprising:
receiving, at an auction management processing device via a computer network, profile data associated with a user of a user device;
receiving, at the processing device via a computer network, a plurality of bids, the plurality of bids corresponding to bids generated by one or more client devices for providing branded creative contents to user devices;
identifying, by the processing device, a subset of the plurality of bids based on the profile data associated with the user;
generating, by the processing device, a set of conditions for identifying a winning bid within the subset of the plurality of bids; and
transmitting, by the processing device via a computer network to the user device or an intermediate device, data descriptive of the subset of the plurality of bids, identifiers of branded creative contents associated with each bid of the subset, and the set of conditions;
identifying by the user device or the intermediate device a winning bid from the subset of bids based on the set of conditions;
retrieving by the user device via a computer network branded creative contents associated with the winning bid based on an identifier associated with the winning bid, the branded creative contents being representative of a brand of an advertiser that generated the winning bid, the branded creative contents being stored on a content storage device separate from the auction management processing device; and
receiving at the auction management processing device an impression event once the creative content associated with the winning bid is retrieved.

2. The method of claim 1, wherein the profile data comprises one or more of geolocation of the user device, demographics, user device data, data related to a messaging application, frequently accessed creative contents, or behavioral data.

3. The method of claim 1, wherein the set of conditions comprises at least one condition related to an action performed with the user device.

4. The method of claim 3, wherein the action is a selection, within a messaging application, of a creative content from a listing of creative contents for insertion into a message, the selected creative content being associated with a particular type of creative contents.

5. The method of claim 4, wherein identifying the winning bid comprises determining that the action performed with the user device satisfies the at least one condition, and wherein the at least one condition is associated with one of the bids of the subset.

6. The method of claim 1, further comprising:
receiving, at the auction management processing device and from the user device via a computer network, an indication of an impression event generated in response to a user selection of one of the creative contents or a display of one of the creative contents by a messaging application to the user; and
computing, by the processing device, a cost to be charged to the client device based on the impression event.

7. The method of claim 1, further comprising:
receiving, at the auction management processing device and from the user device via a computer network, an indication of a share event generated in response to transmission of a message to one or more recipients, the message containing the branded creative contents or indicators thereof; and
computing, by the processing device, a cost to be charged to the client device based on the share event.

8. The method of claim 1, further comprising:
receiving, by the processing device via a computer network, an indication that the user device failed to identify a winning bid within the subset; and
identifying, by the processing device, a winning bid within locally cached bid data.

9. The method of claim 8, further comprising:
performing, by the processing device, an auction to identify additional bids in response to receiving the indication; and
generating, by the processing device, an updated set of conditions for identifying a winning bid.

10. A system comprising:
a memory;
a processing device communicatively coupled to the memory, wherein the processing device is to:
receive profile data associated with a user of a user device;
receive a plurality of bids, the plurality of bids corresponding to bids generated by one or more client devices for providing branded creative contents to user devices;
identify a subset of the plurality of bids based on the profile data associated with the user;
generate a set of conditions for identifying a winning bid within the subset of the plurality of bids; and
transmit, to the user device or an intermediate device, data descriptive of the subset of the plurality of bids, identifiers of branded creative contents associated each bid of the subset, and the set of conditions,
identifying by the user device or the intermediate device a winning bid from the subset of bids based on the set of conditions;
receiving by the user device via a computer network branded creative contents associated with the winning bid based on an identifier associated with the winning bid, the branded creative contents being representative of a brand of an advertiser that generated the winning bid; the branded creative contents being stored on a content storage device separate from the auction management processing device; and
receiving at the auction management processing device an impression event once the creative content associated with the winning bid is retrieved.

11. The system of claim 10, wherein the profile data comprises one or more of geolocation of the user device, demographics, user device data, data related to a messaging application, frequently accessed creative contents, or behavioral data.

12. The system of claim 10, wherein the set of conditions comprises at least one condition related to an action performed with the user device.

13. The system of claim 12, wherein the action is a selection, within a messaging application, of a creative content from a listing of creative contents for insertion into a message, the selected creative content being associated with a particular type of creative contents.

14. The system of claim 13, wherein identifying the winning bid comprises determining that the action performed with the user device satisfies the at least one condition, and wherein the at least one condition is associated with one of the bids of the subset.

15. The system of claim 10, wherein the processing device is further to:
receive, from the user device via a computer network, an indication of an impression event generated in response to a user selection of one of the branded creative contents or a display of one of the branded creative contents by a messaging application to the user; and
computing, by the processing device, a cost to be charged to the client device based on the impression event.

16. The system of claim 10, wherein the processing device is further to:
receiving, from the user device via a computer network, an indication of a share event generated in response to transmission of a message to one or more recipients, the message containing the creative contents or indicators thereof; and
computing, by the processing device, a cost to be charged to the client device based on the share event.

17. The system of claim 10, wherein the processing device is further to:
receiving, by the processing device via a computer network, an indication that the user device failed to identify a winning bid within the subset; and
identifying, by the processing device, a winning bid within locally cached bid data.

18. The system of claim 17, wherein the processing device is further to:
performing, by the processing device, an auction to identify additional bids in response to receiving the indication; and
generating, by the processing device, an updated set of conditions for identifying a winning bid.

19. A non-transitory computer-readable medium having instructions encoded thereon which, when executed by a processing device, cause the processing device to:
receive, by the processing device, profile data associated with a user of a user device;
receive, by the processing device, a plurality of bids, the plurality of bids corresponding to bids generated by one or more client devices for providing branded creative contents to user devices;
identify, by the processing device, a subset of the plurality of bids based on the profile data associated with the user;
generate, by the processing device, a set of conditions for identifying a winning bid within the subset of the plurality of bids; and
transmit, by the processing device to the user device or an intermediate device, data descriptive of the subset of the plurality of bids, identifiers of creative contents associated each bid of the subset, and the set of conditions,
identify by the user device or the intermediate device a winning bid from the subset of bids based on the set of conditions;
retrieve by the user device branded creative contents associated with the winning bid based on an identifier associated with the winning bid, the branded creative contents being representative of a brand of an advertiser that generated the winning bid, the branded creative contents being stored on a content storage device separate from the auction management processing device; and
receiving at the auction management processing device an impression event once the creative content associated with the winning bid is retrieved.

20. A method comprising:
receiving, from an auction management server, a plurality of bids and a set of conditions for identifying a winning bid within the plurality of bids, the plurality of bids corresponding to bids generated by one or more client devices for providing branded creative contents to user devices;
identifying, by a processing device, an action performed by a user with the user device; and
identifying, by the processing device, a winning bid from the plurality of bids by determining that user action satisfies at least one condition within the set of conditions, the winning bid being associated with branded creative content,
wherein the user device is to retrieve the branded creative contents representative of a brand associated with the client device, and wherein the user device is to display a selectable option within a messaging application to insert one or more of the creative contents into a message; and
receiving at the auction management processing device an impression event once the creative content associated with the winning bid is retrieved.
